(19) United States
(12) Patent Application Publication
(10) Pub. No.: US 2009/0078895 A1
(43) Pub. Date: Mar. 26, 2009

(54) Flow Control Valve

(75) Inventor: Marcel Beaulieu, Ste - Therese (CA)

Correspondence Address: Marcel Beaulieu, 67 St. Charles, Ste - Therese, J7E2A5, CA

(73) Assignee: 9145-1328 QUEBEC INC., Ste-Martine, QC (CA)

(21) Appl. No.: 11/569,718

(22) PCT Filed: May 26, 2005
(86) PCT No.: PCT/CA05/00805

§ 371 Date: Nov. 28, 2006

(30) Foreign Application Priority Data
May 28, 2004 (CA) PCT/CA2004/000783

(51) Int. Cl. F16K 31/12

(52) U.S. Cl. 251/35

(57) ABSTRACT

A flow control valve comprising a housing, in turn comprising a substance inlet opening and a substance outlet opening and a substance channel extending between the substance inlet and outlet openings. The valve further comprises: a piston carried by the housing and movable relative thereto; a first biasing member biasing the piston towards a first piston postion in which the piston seals the substance channel; a guide channel carried by the housing; and a valve actuator movable along and whithin the guide channel between first and second actuator positions. Furthermore, the control valve comprises a second biasing member capable of biasing the piston against the bias of the first biasing member towards a second piston position in which the piston clears the substance channel, whereby the bias of the second biasing member overtakes the bias of the first biasing member on the piston when the valve actuator is in the second actuator position, without however overtaking the bias of the first biasing member when the valve actuator is in the first actuator position. When the elongated guide channel is sufficiently tilted, the valve actuator will move from the first actuator position towards the second actuator position resulting in the bias of the second biasing member overtaking the bias of the first biasing member on the piston and the piston thus being moved towards the second piston position. The movement of the piston is delayed according to the time it takes for the valve actuator to move from the first actuator position to the second actuator position.

### CROSS-REFERENCE DATA

The present patent application claims priority of international patent application number PCT/CA2004/000783 filed May 28, 2004.

### FIELD OF THE INVENTION

The present invention relates to flow control valves, and more particularly to a flow control valve for controlling the flow of a substance therethrough.

### BACKGROUND OF THE INVENTION

Some known control valves for fluids, especially for liquids, include security devices which will prevent the container equipped with the valve from overflowing. The container comprises an opening at its upper portion, where the valve is installed. The valve includes a buoyant floating element that allows liquid to flow into the container in a default condition of the valve. In this default condition of the valve, the floating element is biased away from the container opening, for example under its own weight. Upon the container being overfilled with liquid, some liquid will overflow into the valve and the buoyant floating element will be carried by the liquid towards a position in which it closes in fluid-tight fashion the container opening: the valve then becomes in an overfilled condition that prevents liquid from flowing through the valve, either into the container or out of the container.

The above-described valve meets the purpose for which it was designed. However, no valve allowing the liquid flow therethrough to be suitably controlled is known to the applicant.

### SUMMARY OF THE INVENTION

The present invention relates to a flow control valve for controlling the flow of a substance capable of flowing therethrough, said flow control valve comprising:
a housing comprising a substance inlet opening, a substance outlet opening and a substance channel extending between said substance inlet and outlet openings for allowing the substance to flow through said flow control valve;
a piston carried by said housing and movable relative to said housing between a first piston position in which said piston seals said substance channel for preventing the substance from flowing therethrough, and a second piston position in which said piston clears said substance channel for allowing the substance to flow therethrough;
a first biasing member continuously biasing said piston towards a constant one of said first and second piston positions;
a guide channel carried by said housing;
a valve actuator movable along and within said guide channel between first and second actuator positions,
a second biasing member capable of biasing said piston against the bias of said first biasing member towards the one of said first and second piston positions opposite said constant one of said first and second piston positions, whereby the bias of said second biasing member overtakes the bias of said first biasing member on said piston when said valve actuator is in said second actuator position, without however overtaking the bias of said first biasing member when said valve actuator is in said first actuator position so that said piston will remain in said constant one of said first and second piston positions when said valve actuator is in said first actuator position;
wherein upon said elongated guide channel being positioned beyond a determined threshold angular position relative to a horizontal axis, said valve actuator will progressively move from said first actuator position towards said second actuator position resulting in the bias of said second biasing member overtaking the bias of said first biasing member on said piston and said piston thus being moved towards the one of said first and second piston positions opposite said constant one of said first and second piston positions, with the movement of said piston being delayed according to the time it takes for said valve actuator to move from said first actuator position to said second actuator position.

In one embodiment, said second biasing member comprises a piston magnetic member carried by said piston, and an actuator magnetic member carried by said valve actuator that can magnetically cooperate with said piston magnetic member. At said second actuator position of said valve actuator, magnetic interaction forces between said piston and actuator magnetic members will overtake the bias of said first biasing member on said piston to move said piston towards said one of said first and second piston positions opposite said constant one of said first and second piston positions.

In one embodiment, said first biasing member includes an auxiliary magnetic member carried by said housing that magnetically cooperates with said piston magnetic member to continuously bias said piston towards said constant one of said first and second piston positions.

In one embodiment, said actuator magnetic member is an actuator magnet, said auxiliary magnetic member is an auxiliary magnet and said piston magnet member is a metallic member attracted by both said actuator and auxiliary magnetic members.

In one embodiment, said housing further comprises an air channel at least partly distinct from said substance channel and extending through said valve housing for allowing air to flow through said valve in at least one of said first and second piston positions.

In one embodiment, said auxiliary magnetic member is movable between a first auxiliary position in which said auxiliary magnetic member seals said air channel for preventing air from flowing therethrough, and a second auxiliary position in which said auxiliary magnetic member clears said air channel for allowing air to flow therethrough.

In one embodiment, said guide channel is a fluid-tight elongated inner chamber in which said valve actuator is movable, said inner chamber containing an inner chamber fluid that dampens and consequently delays the movement of said valve actuator between said first and second actuator positions.

In one embodiment, said valve actuator is a floater having a lesser density than that of said inner chamber fluid.

In one embodiment, said second biasing member comprises an actuator attachment member linking said valve actuator to said piston and extending through a wall of said inner chamber in a fluid-tight fashion.

In one embodiment, said attachment member is flexible.

The present invention also relates to a flow control valve for controlling the flow of a substance capable of flowing therethrough, said flow control valve comprising:
a housing comprising a substance inlet opening, a substance outlet opening and a substance channel extending between said substance inlet and outlet openings for allowing the substance to flow through said flow control valve;
a piston carried by said housing and movable relative to said housing between a first piston position in which said piston seals said substance channel for preventing the substance from flowing therethrough, and a second piston position in which said piston clears said substance channel for allowing the substance to flow therethrough;
a biasing member continuously biasing said piston towards a constant one of said first and second piston positions;
an elongated guide channel within said housing; and
a valve actuator movable along and within said elongated inner chamber between first and second actuator positions, said valve actuator operatively communicating with said piston, and said valve actuator capable of exerting an actuator force on said piston which increases when said valve actuator moves from said first to said second position, said actuator force being opposite to the bias exerted by said biasing member on said piston;
wherein upon said elongated inner chamber being positioned beyond a determined threshold angular position relative to a horizontal axis, said valve actuator will move towards said second actuator position said actuator force will overtake the bias exerted on said piston by said biasing member and said piston will thus be moved towards the one of said first and second positions opposite said constant one of said first and second positions, with the movement of said piston being delayed according to the time it takes for said valve actuator to move from said first actuator position to said second actuator position.

In one embodiment, said guide channel is a fluid-tight inner chamber tight and defines an inner chamber wall enclosing a fluid, said valve actuator has a different density than that of said fluid, said valve actuator and said piston operatively communicate through the instrumentality of an actuator attachment member linking said valve actuator to said piston and extending through said inner chamber wall in a fluid-tight fashion, wherein upon said elongated inner chamber being positioned beyond a determined threshold angular position relative to a horizontal axis, the movement of said piston between said first and second positions will be delayed by the fact that the movement of said valve actuator within said inner chamber will be dampened by said fluid.

In one embodiment, said valve actuator is a float member having a lesser density than that of said fluid.

In one embodiment, said actuator attachment member comprises a flexible element, and the overtaking of the bias of said biasing member by said actuator force to move said piston towards said one of said first and second positions opposite said constant one of said first and second positions is delayed until said flexible element becomes taught between said valve actuator and said piston after said inner chamber is moved to be positioned beyond said determined threshold angular position.

In one embodiment, said biasing member comprises first and second portions magnetically attracted to each other and respectively provided on said housing and on said piston.

In one embodiment, said float member comprises a skirt impeding the displacement of said float member towards a constant determined direction within said inner chamber.

In one embodiment, said piston comprises a metallic member moving integrally therewith, and said valve actuator is slidable within said guide channel and comprises a valve actuator magnet located much closer from said piston metallic member when said valve actuator is in its said second position than when it is in its said first position, said valve actuator magnet capable of exerting a magnetic attraction force on said metallic member, said magnetic attraction force being said actuator force, wherein said magnetic attraction between said piston metallic member and said valve actuator magnet establishes operative communication between said piston and said valve actuator.

In one embodiment, said biasing member comprises said metallic member attached to said piston and a biasing member magnet connected to said housing, said biasing member magnet and said metallic member continuously attracting each other.

In another embodiment, said biasing member magnet is movable between a first position adjacent to said metallic member, and a second position relatively farther from said metallic member, said biasing member magnet and said valve actuator magnet being in mutually repelling arrangement, wherein when said valve actuator is moved in its second position, said biasing member magnet is repelled by said valve actuator magnet and moved in its second position.

In yet another embodiment, said housing further comprises an air channel at least partly distinct from said substance channel and extending through said valve housing for allowing air to flow through said valve in at least one of said first and second positions of said piston.

### DESCRIPTION OF THE DRAWINGS

In the annexed drawings:

FIG. 1 is a perspective view of a flow control valve according to one embodiment of the present invention operatively installed in a container, with the container being partly cut-away to show the valve extending therein;

FIG. 2 is an enlarged partial perspective view of the valve of FIG. 1 in which the different radially sequential layers are partly cut-away to show the inner components of the valve, with the piston being in its first position in which it seals off the liquid channel and with the buoyant float member being in a position near the extremity of the inner fluid chamber adjacent the seal member;

FIG. 3 is similar to FIG. 2, but with the piston being in its second position in which it clears the liquid channel and with the buoyant float member being in a position near the extremity of the inner fluid chamber opposite the seal member;

FIG. 4 is a diametrical cross-sectional view of the valve of FIG. 1 with the piston and float member being positioned as in FIG. 2, and with the air tube being only partly shown;

FIG. 5 is a diametrical cross-sectional view of the valve of FIG. 1 with the piston and float member being positioned as in FIG. 3, with the air tube being only partly shown, and suggesting with full-line arrows the flow of liquid to be poured through the valve, and suggesting with dotted-line arrows the flow of air through the valve;

FIG. 6 is an exploded perspective view of the fluid control valve of FIG. 1, with the inner casing being partly cut-away to show the inner elements otherwise concealed by the casing, and with the unitary piston and unitary outer housing being separated in two parts normally integrally linked to each other to also help illustrate the inner elements of the valve;

FIG. 7 is a partial enlarged perspective view of the liquid outlet end of the valve of FIG. 1, suggesting with full-line arrows the flow of liquid to be poured through the valve, and suggesting with dotted-line arrows the flow of air through the valve;

FIG. 8 is an exploded perspective view of a flow control valve according to another embodiment of the invention, with the unitary tubular housing being separated in two parts to help illustrate the inside content of the valve;

FIG. 9 is a diametrical cross-sectional view of the valve of the embodiment FIG. 8, showing the valve in its closed condition; and

FIG. 10 is a view similar to that of FIG. 9, but showing the valve in its open condition.

### DETAILED DESCRIPTION OF THE EMBODIMENTS

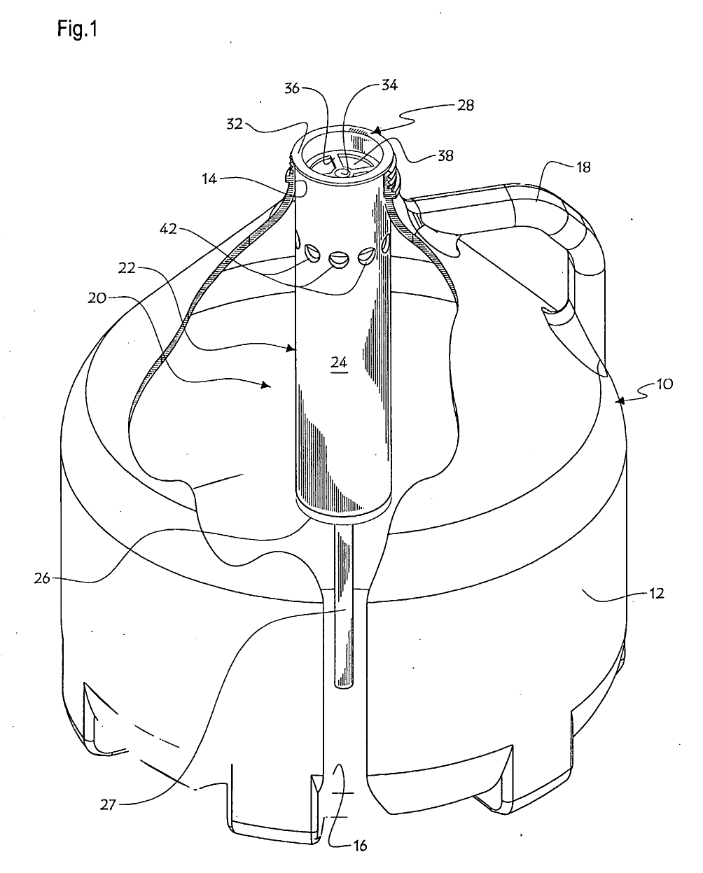

FIG. 1 shows a conventional container 10 of the type defining a peripheral wall 12 having a top mouth opening 14, a bottom wall 16 and a handle 18. Container 10 is equipped with a flow control valve 20 according to one embodiment of the present invention. Container 10 is destined to contain any type of substance capable of flowing, such as a fluid (liquid or gas) or a granular material, hereafter generally referred to as “the substance”. The purpose of flow control valve 20 is to control the flow of the substance therethrough, and also through the container mouth opening 14 since control valve 20 extends through mouth opening 14. In the embodiment of the flow control valve 20 shown in the annexed drawings, flow control valve 20 is especially designed to be used to control the flow of a liquid provided in container 10, and referenced will hereafter be often be made to a liquid, although it is understood that this does not limit the usability of the flow control valve of the present invention with substances other than liquids, such as gases or granular solids.

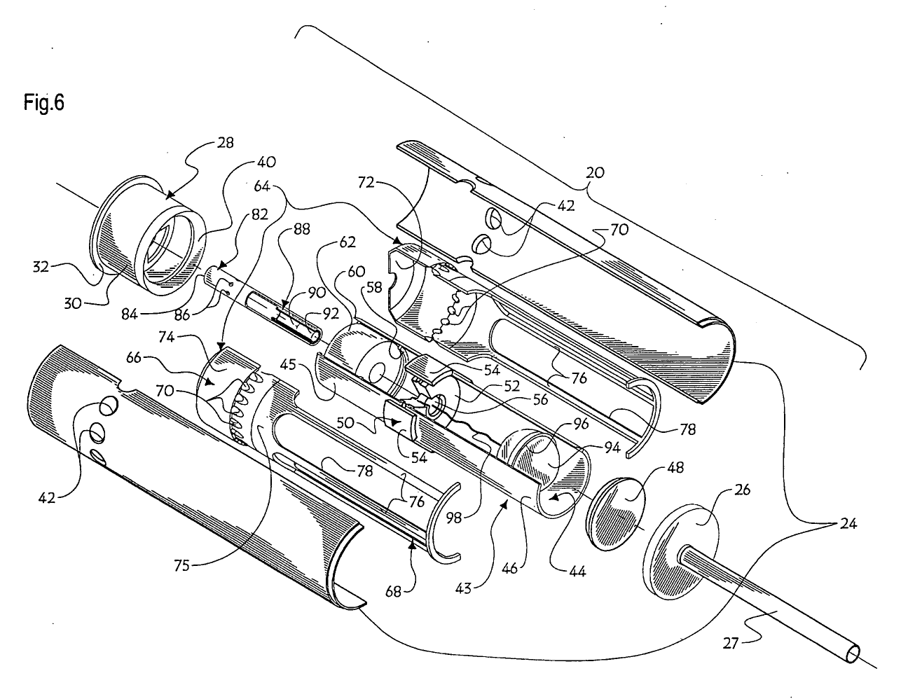

FIGS. 1-7 show that flow control valve 20 comprises a tubular, elongated housing 22 defining opposite first and second ends 22a and 22b and having a cylindrical peripheral wall 24 and an end wall 26 integrally attached to peripheral wall 24 and closing same at the housing second end 22b. End wall 26 is provided with an integral air outlet tube 27 extending outwardly of valve housing 22 and communicating with a central bore made in end wall 26.

A cover 28 is installed on peripheral wall 24 at housing first end 22a and is fixedly attached thereto. Cover 28 comprises a peripheral wall 30 extending partly within the housing peripheral wall 24 and having an outwardly projecting peripheral flange 32 abutting on the rim of housing peripheral wall 24. Cover 28 is further provided with a central web 34 linked to cover peripheral wall 30 by an array of angularly spaced-apart, radially extending ribs 36 defining outlet openings 38 therebetween that allow liquid to flow out of valve 20. An inwardly projecting peripheral abutment shoulder 40 is provided on cover peripheral wall 30 at its extremity opposite flange 32.

Peripheral wall 24 also comprises a number of inlet openings 42 near first end 22a and spacedly adjacent to cover abutment shoulder 40 towards second end 22b. A liquid (or substance) channel is defined between inlet openings 42 and outlet openings 38 to allow liquid to flow from the main chamber of container 10, and through inlet and outlet openings 42 and 38, as described hereinafter.

An elongated tubular inner casing 43 is defined within housing 22. Inner casing 43 comprises a guide channel in the form of a tubular inner chamber 44 generally coextensive with a magnet sleeve 45.

Inner chamber 44 comprises a tubular peripheral wall 46 and an end wall 48 closing in fluid-tight fashion the extremity of peripheral wall 46 adjacent the housing second end 22b. Inner chamber end wall 48 is more particularly located spacedly adjacent to the housing end wall 26 to allow fluid such as air to flow between the inner chamber and housing end walls 26, 48, as described hereinafter.

A seal member 50 is located at the end of inner chamber 44 opposite end wall 48, between inner chamber 44 and magnet sleeve 45. Seal member 50 comprises an annular wall 52 supported by a few, for example four, peripherally spaced-apart arcuate brackets 54 that are press-fitted within housing peripheral wall 24, and within which the extremity of the inner chamber peripheral wall 46 is press-fitted. Annular wall 52 has a central bore equipped with a resilient seal 56 which can be for example made of rubber, so as to form a fluid-tight enclosure within inner chamber 44.

Magnet sleeve 45 is press-fitted within the seal member brackets 54 so as to be generally coextensive with the inner chamber peripheral wall 46, although located on the opposite side of seal member annular wall 52. Magnet sleeve 43 is generally tubular, and comprises two spaced-apart annular ribs 58, 60 between which an annular magnet 62, slidably mounted within magnet sleeve 43, is movable.

Seal member 50 thus not only seals off the extremity of inner chamber peripheral wall 46 adjacent magnet sleeve 45, but it also holds inner casing 43 within housing 22 spacedly from peripheral wall 24 so that a radial play exists between inner chamber peripheral wall 46 and housing peripheral wall 24, and between magnet sleeve 43 and housing peripheral wall 24.

Valve 20 further comprises a generally cylindrical piston 64 including a head portion 66 and a main body 68 which is diametrically slightly smaller than head portion 66. Head portion 66 includes an end wall 72 and a tubular peripheral wall 74 which is generally coextensive with the tubular main body 68 of piston 64 which is also generally tubular. A number of inclined openings 70 are provided at the junction between head portion 66 and main body 68.

Piston main body 68 comprises a cylindrical wall portion 75 adjacent head portion 66 from which depend a number of longitudinally extending, peripherally spaced-apart, parallel rods 76 sequentially arranged in a cylindrical disposition and defining longitudinal openings 78 therebetween. Rods 76 are linked by a ring 80 at their extremity opposite cylindrical wall portion 75.

Piston 64 is located within housing 22 so that piston main body 68, and the head portion cylindrical wall 74 in some positions of piston 64 as detailed hereinafter, extend between the spaced-apart housing peripheral wall 24 and inner casing 43. More particularly, piston 64 is positioned so that the spaced-apart seal member brackets 54 are fitted in corresponding piston longitudinal openings 78. In this position, piston 64 is longitudinally slidable within housing 22 between a first position in which piston head portion 66 seals the liquid channel formed between the inlet and outlet openings 42 and 38 for preventing liquid from flowing through flow control valve 20, and a second position in which piston head portion 66 clears the liquid channel formed between inlet and outlet openings 42, 38 for allowing liquid to flow through control valve 20. This sealing of the liquid channel is accomplished by the piston head portion peripheral wall 74 obstructing the valve inlet opening 42 in a fluid-tight fashion, and with the piston head portion end wall 72 simultaneously sealingly abutting with a bevelled surface thereof against the cover abutment shoulder 40. However, it is understood that piston 64 could alternately seal the liquid channel in a different manner, at any position between the liquid inlet and outlet openings 42, 38. The movement of piston 64 between its above-mentioned first and second positions will be described hereinafter in greater detail.

Piston head portion 66 comprises a tube 82 integrally attached thereto and extending on one side and the other of head portion end wall 72 through a central bore made in end wall 72. Tube 82 comprises an air inlet opening 84 at a first extremity thereof, and a number of air outlet openings 86 provided on the tube peripheral wall inside piston head portion 66, adjacent head portion end wall 72. A metallic insert 88 comprising a metallic sleeve 90 and a short metallic plug 92 is fixedly attached at the extremity of tube 82 opposite air inlet opening 84. Metallic insert 88 and magnet 62 are mutually attracted to each other, and it is understood that insert 88 could alternately be a magnet while magnet 62 could be a metallic ring, as long as mutual magnetic attraction between elements 88 and 62 exists.

A valve actuator in the form of a buoyant float member 94 is provided in inner chamber 44 and is movable therein. Float member 94 is spherical and comprises a semi-flexible skirt 96 oriented towards the housing second end 22b. Float member 94 is distally attached to metallic plug 92 by means of a string 98 slidably extending through resilient seal 56 in a fluid-tight fashion, the latter being pierced for this purpose.

In use, valve 20 may be installed on a liquid container 10 as shown in FIG. 1, i.e. at the top mouth opening 14 of container 10. In this position, the valve housing peripheral wall 24 frictionally engages the inner wall of container mouth opening 14, so as to prevent any liquid from seeping between valve housing peripheral wall 24 and container mouth opening 14. The valve 20 extends inside container 10, with the housing first end 22a thus being positioned at the container mouth opening 14 and with the housing second end 22b being located inside container 10. Air tube 27 extends inwardly of container 10, preferably so that its free extremity is located near, although at least slightly spaced from, the container bottom wall 16.

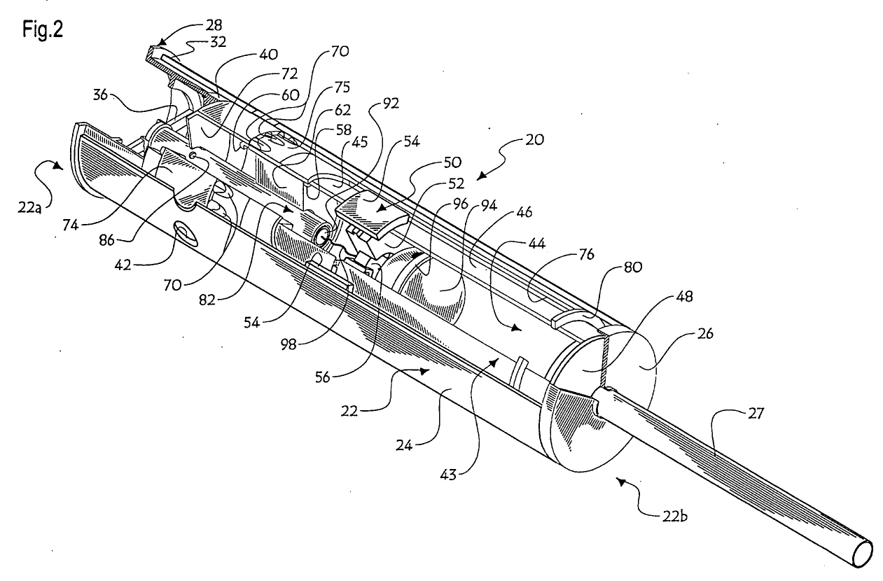

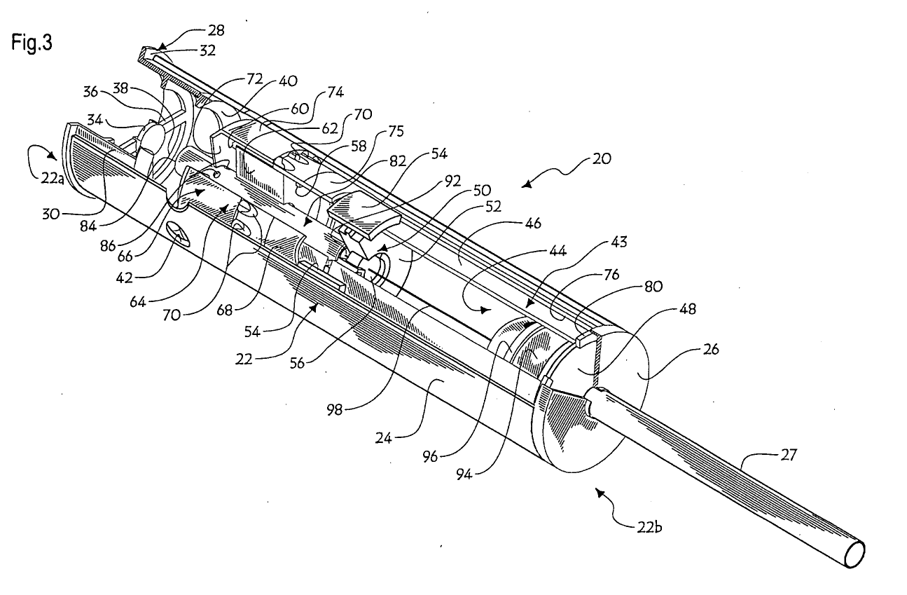

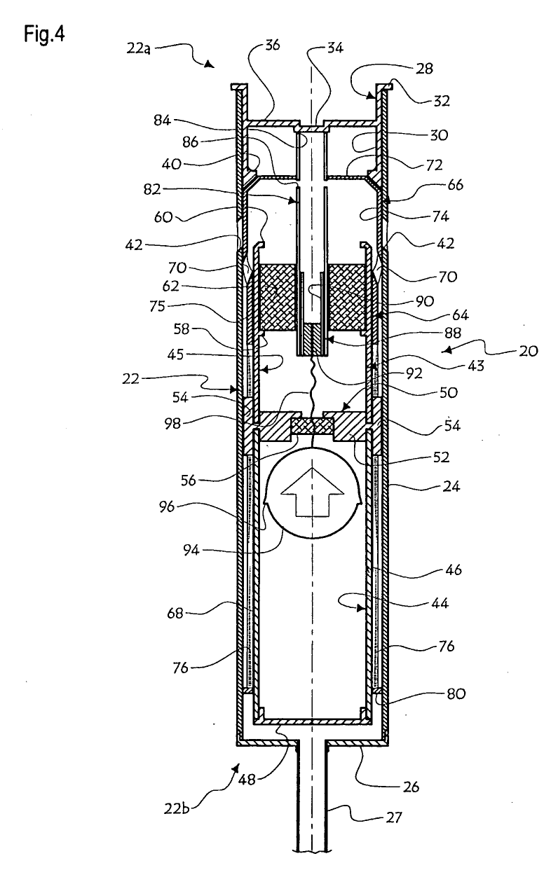

As noted hereinabove, piston 64 is movable between:
a first position shown in FIGS. 2 and 4 in which the piston head portion 66 seals the liquid inlet openings 42 to prevent liquid from flowing therethrough, in which a bevelled surface of piston head portion 66 abuts against the cover abutment shoulder 40, in which the tube air inlet opening 84 abuts against the circular cover central web 34, and in which the piston main body ring 80 is located longitudinally between the inner chamber end wall 48 and the seal member brackets 54 to at least partly seal off the peripheral passage between the inner chamber peripheral wall 46 and the housing peripheral wall 24; and
a second position shown in FIGS. 3, 5 and 7, in which the piston head portion 66 clears the liquid inlet openings 42 to allow liquid to flow therethrough, in which the tube air inlet opening 84 clears the circular cover central web 34 to allow air to flow through tube 82, and in which the piston main body ring 80 is longitudinally located spacedly under the inner chamber end wall 48 to allow air to flow from the peripheral passage between the inner chamber peripheral wall 46 and the housing peripheral wall 24, to the air outlet tube 27.

The magnet and metallic insert assembly 62, 88 cooperate to act as a biasing member that continuously biases piston 64 towards its above-mentioned first position. Indeed, the mutual attraction of magnet 62 and metallic insert 88 will continuously pull metallic insert 88 towards the housing first end 22a since the magnetic center of metallic insert 88 is located between magnet 62 and housing second end 22b at all times. The position of this magnetic center is influenced mostly by the magnetically denser metallic plug 92, although metallic sleeve 90 is also attracted by magnet 62. Since metallic insert 88 is fixedly attached to inner tube 82 which is in turn integrally fixed to piston 64, the magnetic attraction between magnet 62 and metallic insert 88 will result in piston 64 being continuously biased towards housing first end 22a, i.e. towards its first limit position.

In an upright position of valve 20 shown in FIGS. 1, 2 and 4, piston 64 will be located at its first position under the continuous bias of the magnet and metallic insert assembly 62, 88, with the latter, in conjunction with the friction forces between piston 64 and housing 22 and between piston 64 and inner casing 43, counter-acting the action of the gravity on piston 64. In this upright position of valve 20, float member 94, which floats in the fluid located in inner chamber 44, will further be biased towards the housing first end 22a, and string 98 will consequently loosely link metallic insert 88 and float member 94. In this upright position where piston 64 is in its first position and seals the liquid channel defined between inlet openings 42 and outlet openings 38, valve 20 is said to be in a closed condition.

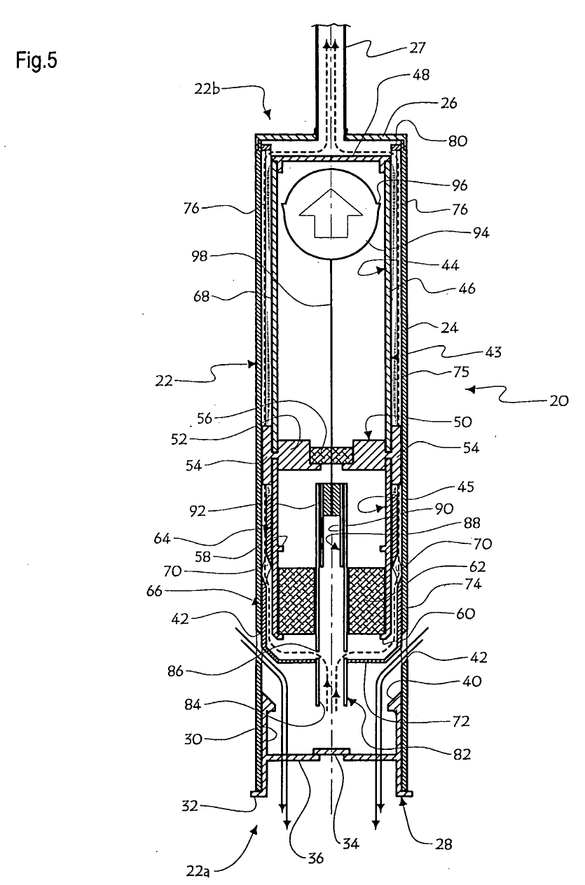

Upon container 10 and valve 20 being tilted beyond a determined threshold angular position relative to a horizontal axis for the purpose of pouring some liquid out of container 10, some liquid will flood the inner area of container 10 near its mouth opening 14 so that some liquid may flow into the valve inlet openings 42. In this tilted position of valve 20, piston 64 will move from its first position to its second position. In the embodiment shown in the annexed drawing, this threshold angular value can for example require that the elongated valve 20 be positioned with the housing second end 22b at a higher position relative to the housing first end 22a so that the buoyant float member 94 will float from the first end of the fluid-filled inner chamber near the seal member 50 towards the second end of the inner chamber near the inner chamber end wall 48. For example, valve 20 can be positioned upside down relative to its upright position, as shown in FIG. 5, although it is understood that a downwardly inclined position would also be functional. Upon the buoyant float member 94 moving in this way towards the inner chamber end wall 48, string 98 will gradually become taught between float member 94 and metallic insert 88 until float member 94 literally pulls on metallic insert 88 to force piston 66 towards its second position, against the action of the magnetic attraction between metallic insert 88 and magnet 62 and also against the gravity and frictions forces all acting to maintain piston 64 in its first position. Piston 64 will slide towards its second position due to the sliding engagement of inner tube 82 within the central bore of magnet 62, due to the sliding engagement of the peripheral wall 74 of piston head portion 66 along the inner surface of housing peripheral wall 24, and due to the sliding engagement of piston main body 68 along inner casing 43, including the piston main body ring 80 that slides between inner casing 43 and housing peripheral wall 24.

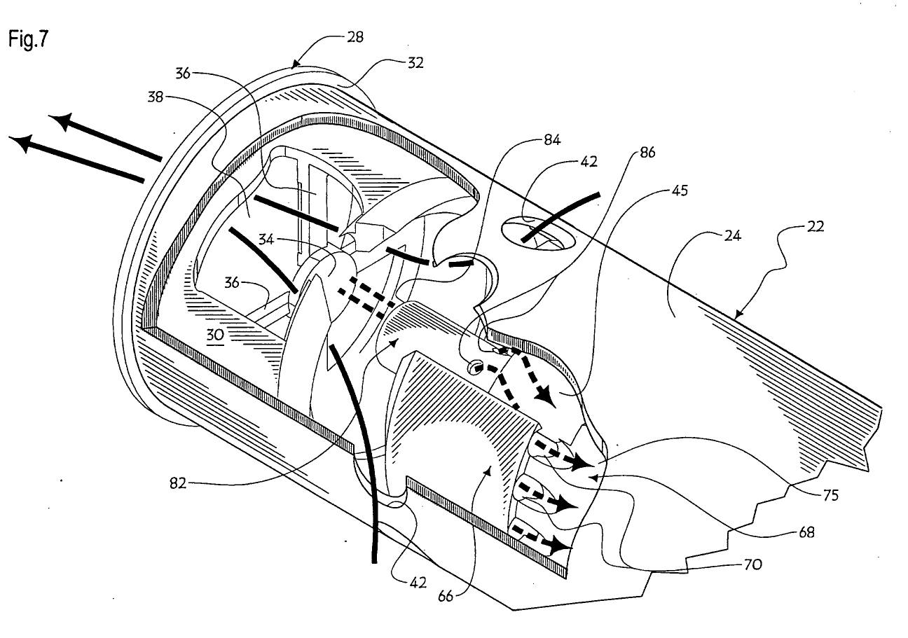

In this second position of piston 64, as shown particularly in FIGS. 5 and 7, piston head portion 66 clears inlet openings 42 and liquid from container 10 may flow through the valve inlet openings 42 and the valve outlet openings 38 to pour out of container 10; in this position of piston 64, valve 20 is said to be in an open condition. Simultaneously, air may flow sequentially through the air inlet opening 84 of inner tube 82, through the air outlet openings 86 of inner tube 82 into the area located within the piston head portion 66, through the piston inclined openings 70, then through the peripheral passage located between housing peripheral wall 24 and inner casing 43, with the air circulating between the peripherally spaced-apart seal member brackets 54, then around and under the inner casing end wall 48, passing between the latter and the piston main body ring 80, and finally out through air tube 27 into the container. This incoming air flow will of course promote a more steady liquid flow out of container 10 since it will not be necessary for the air to flow through the valve liquid inlet openings 42—which air is required to prevent a vacuum from being created within container 10 due to the outpouring of liquid.

Upon valve 20 being tilted back towards an upright position for the purpose of stopping the liquid flow out of container 10, and more generally upon valve 20 being tilted in an angular position beyond a determined threshold angular position relative to a horizontal axis e.g. with housing first end 22a being positioned higher than housing second end 22b such as the vertical upright position shown in FIG. 4 for example, piston 64 will move back from its second position to its first position. Indeed, in an upright position of valve 20, float member 94 will cease to act on piston 64 through the instrumentality of string 98 and it will float back towards seal member 50 as shown in FIG. 4, with string 98 becoming loose once again. With the absence of any pulling force exerted by float member 94 on piston 64, the continuous bias of piston 64 towards its first position due to the mutual attraction of magnet 62 and metallic insert 88 will move piston 64 back to its first limit position since metallic insert 88 will be pulled back towards and partly into the central bore of magnet 62. This magnetic attraction will counteract the gravity and friction forces which will act to maintain piston 64 in its second position.

According to the present embodiment of the invention, the movement of piston 64 from its first to its second position will be delayed by the fact that the movement of float member 94 within inner chamber 44 will be dampened by the fluid in inner chamber 44. Also, the action of float member 94 on piston 64 to force piston 64 towards its second position is delayed until the string becomes taught between float member 94 and piston 64 after valve 20 is tilted to be positioned beyond its determined threshold angular position.

It is possible to calibrate the movement of float member 94 to allow the corresponding delayed movement of piston 66 to also be calibrated when valve 20 is tilted beyond its determined threshold angular position to provoke a liquid outflow. Indeed, depending on the viscosity of the fluid located in inner chamber 44 and on the diameter ratio between float member 94 and inner chamber 44, the displacement speed of float member 94 will vary for a same angular position of valve 20, e.g. the inverted upright position of valve 20 shown in FIG. 5. Furthermore, providing a unidirectional semi-flexible skirt such as skirt 96 on float member 94 will allow to slow the progression of float member 94 in one direction only, namely when float member 94 moves towards casing second end 22b in the embodiment shown in the annexed drawings. This will delay the movement of piston 64 from its first to its second position.

Furthermore, as indicated hereinabove, providing a flexible string 98 to establish operative communication between float member 94 and piston 64 also allows a delay to be set before piston 64 moves from its first to its second position when valve 20 is tilted from an upright position shown in FIG. 4 to an inverted position shown in FIG. 5. Indeed, upon valve 20 being tilted into an inverted position, float member 94 will gradually move away from a first extremity of inner chamber 44 near seal member 50 towards the opposite extremity. This will have no immediate effect on piston 64 since float member 94 will not act on piston 64 until string 98 becomes taught. Consequently, there will be a first phase of the displacement of float member 94 in which string 98 will be at least slightly loose and in which consequently no pulling force will be exerted by float member 94 on piston 64; and a second phase of the displacement of float member 94 in which string 98 will be taught and in which the movement of float member 94 will result in a corresponding displacement of piston 64 from its first to its second position.

Such a delay in the displacement of piston 64 can be advantageous. Indeed, this delay in the displacement of piston 64 will result in a delay before the liquid in container 10 is poured when the valve-equipped container 10 is tilted into an inverted position to pour the liquid. Thus, for example, if container 10 is accidentally knocked over, it can be restored into an upright position before liquid accidentally pours out of container 10. Also, it becomes possible to first tilt the container 10 into an inverted position, and then to engage the container top mouth opening 14 into a corresponding mouth opening of a recipient (not shown), before liquid starts to pour out of container mouth opening 14. This helps prevent liquid from accidentally being spilled near the recipient opening without being actually poured into the recipient opening since without a valve 20, liquid may start to pour out of container 10 when an inclined position of container 10 is reached, but before the top mouth 14 of container 10 is actually engaged in the recipient opening.

It is understood that the displacement speed of piston 64 may be selectively calibrated not only by changing the viscosity of the fluid in inner chamber 44, the diameter ratio between float member 94 and inner chamber 44 or the resistance conferred by the float member skirt 96, but also by changing the attachment member linking float member 94 to piston 64. Indeed, the length of string 98 may be changed to modify the reaction delay for the movement of piston 64 once valve 20 is tilted in an inverted position; or string 98 could be literally replaced by a rigid attachment member such as a thin rod for example (not shown), which would allow piston 64 to be moved towards its second position immediately upon the valve being inverted. A rigid attachment member would also cooperate with the magnet and metallic insert assembly 62, 88 in moving piston 64 towards its first limit position when valve 20 is tilted back into its upright position of FIG. 4, since float member 94 would push on piston 64 when moving towards seal member 50.

Any suitable biasing member could alternately be used instead of the magnet and metallic insert assembly 62, 88, such as a coil spring, a resilient pad or any other biasing member capable of continuously biasing piston 64 towards its first position.

It is noted that providing a metallic insert 88 comprising a metallic sleeve 90 having a lower magnetic density than that of the metallic plug 92 and which extends further into the inner tube 82 than plug 92, is advantageous since it allows the magnetic attraction force between magnet 62 and metallic insert 88 to increase even more exponentially as insert 88 approaches magnet 62. Thus, little magnetic attraction would exist between magnet 62 and metallic insert 88 when piston 64 is in its second position shown in FIG. 5 due to the relatively important distance between metallic plug 92 and magnet 62, although a non-negligible albeit smaller magnetic attraction force would still exist due to the proximity of metallic sleeve 90 and magnet 62; while a larger magnetic attraction would exist between metallic insert 88 and magnet 62 when piston 64 is in its first position due to the fact that not only metallic sleeve 90 but also metallic plug at least partly engage the central bore of magnet 62, as shown in FIG. 4.

Also, the fact that magnet 62 is slidable, under the influence of gravity, between the two annular ribs 58, 60 provided inside magnet sleeve 45 will allow magnet 62 to slide towards one or the other rib 58, 60 depending on the angular position of valve 20. Indeed, when valve 20 has its housing first end 22a above its housing second end 22b as in FIG. 4, magnet 62 will be seated on rib 58 and magnet 62 will consequently be located closer to metallic insert 88, which will increase the magnetic attraction between magnet 62 and metallic insert 88. However, if valve 20 is tilted so that its housing first end 22a becomes positioned lower than its housing second end 22b as in FIG. 5, metallic insert 88 will slide towards and become seated against the other rib 60 and magnet 62 will consequently be located farther away from metallic insert 88, decreasing the mutual attraction between magnet 62 and metallic insert 88.

The float member 94 of the valve of the present embodiment of the invention could be replaced by a valve actuator having a density which is greater than that of the fluid of the valve inner chamber in which the valve actuator is located. In such a case, the valve actuator would be a weight instead of a float, although its movement along and within the valve inner chamber could also be controlled according to the teaching of the present invention. The valve piston would then still be actuated by the valve actuator upon the valve being tilted beyond a determined threshold angular value, and a delay would still exist in the displacement of the piston depending inter alia on the viscosity of the fluid in which the valve actuator would be submerged, on the diameter ratios between the valve actuator and the inner chamber in which it is located, and on whether the valve actuator operatively communicates with the piston with a flexible string or a more rigid attachment member.

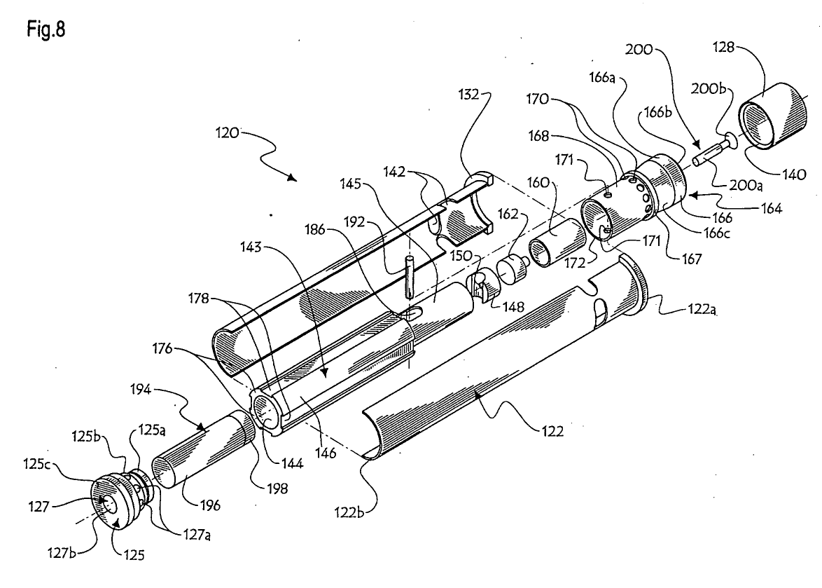

FIGS. 8-10 show a control valve 120 according to an alternate embodiment of the present invention. Valve 120 comprises a cylindrical tubular housing 122 defining top and bottom open ends 122a and 122b respectively, the opening in housing first end 122a acting as the outlet opening 138 of valve 120. Housing 122 has a peripheral abutment flange 132 extending integrally radially outwardly of its top end 122a. When valve 120 is inserted in the mouth opening of a container (such as container 10 shown in FIG. 1), the abutment flange 132 will rest on the outer rim of the container's mouth opening.

A number of peripherally spaced valve inlet openings 142 are made around housing 122 and have an oblong shape for example (as best seen in FIG. 8). A liquid (or substance) channel is defined between inlet openings 142 and valve outlet opening 138 to allow liquid to flow from the main chamber of the container in which the valve is installed, through inlet opening 142 and out of valve 122 through outlet opening 138.

An inner lining 128, made of plastic for example, is friction-fitted in the lumen of tubular housing 122, between inlet openings 142 and outlet opening 138. Lining 128 is cylindrical, and has an inner peripheral abutment chamfer 140 made on its end facing housing bottom end 122b.

An elongated tubular inner casing 143 is nested within the lumen of-housing 122, between lining 128 and housing bottom end 122b. Inner casing 143 defines an elongated tubular main body portion 146, and an elongated and hollow magnet sleeve portion 145 integrally and coaxially extending from main body portion 146. Main body portion 146 has a generally greater outer diameter than hollow magnet sleeve portion 145 and an annular abutment shoulder 147 is hence created at their junction.

The inner casing's main body portion 146 has an outer surface on which are formed a number of peripherally spaced-apart longitudinal ridges 176, and air circulation grooves 178 are formed between each pair of consecutive ridges 176. The outer surface of each one of ridges 176 is arcuate and fits snugly against the inner wall of tubular housing 122, while grooves 178 clear the inner wall of housing 122.

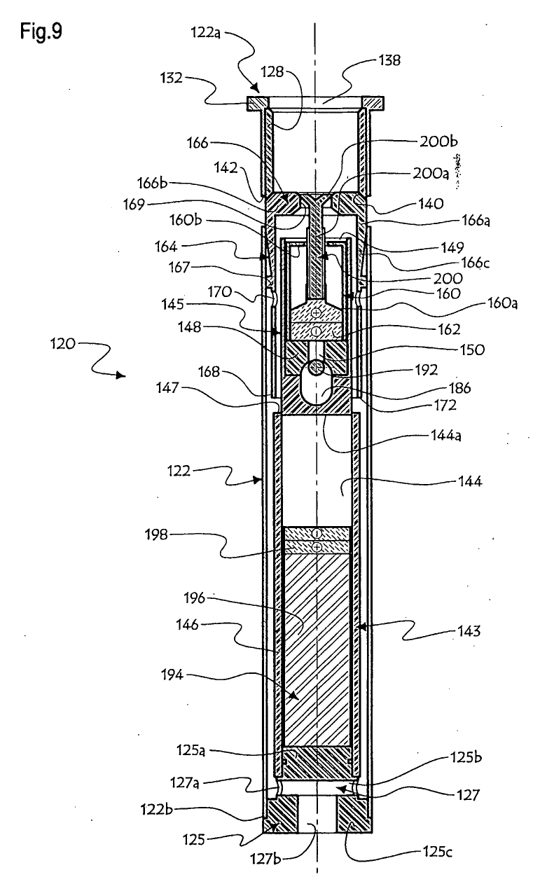

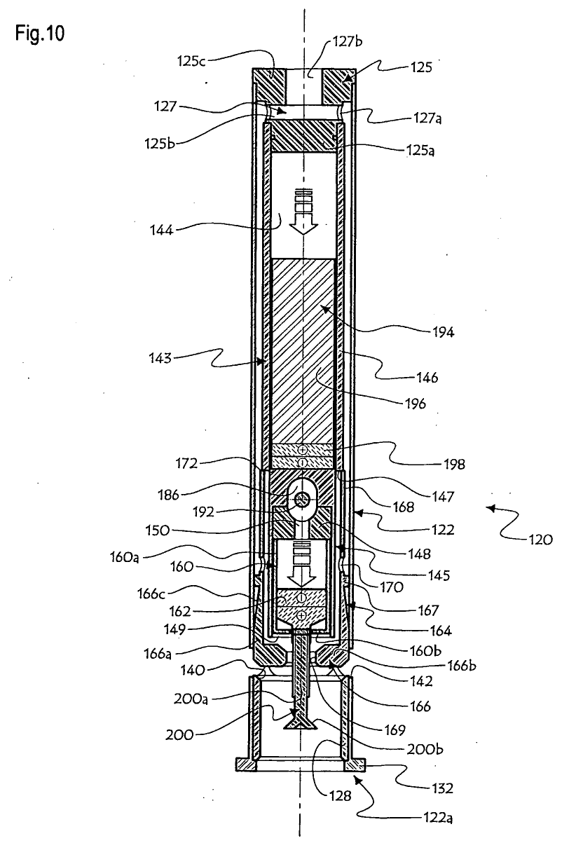

The inner casing's main body portion 146 further defines a guide channel in the form of a generally cylindrical inner chamber 144, in which a valve actuator 194 is slidably fitted, and which is closed off by a valve endpiece 125 fitted in its free open end. Valve actuator 194 has a generally cylindrical shape of generally uniform diameter, and is composed of an elongated cylindrical weigh 196 to which a bipolar valve actuator magnet 198 is coextensively affixed, using a suitable adhesive for example. As can be seen in FIGS. 8-10, cylindrical valve actuator 194 has a slightly smaller diameter than the inner chamber 144 in which it is confined, which allows it to be freely slidable therein. Moreover, valve actuator 194 is generally shorter than inner chamber 144, thus providing a longitudinal play allowing substantial axial movement of valve actuator 194 along chamber 144 between two limit positions, a first limit position where valve actuator 194 abuts against endpiece 125 (FIG. 9), and a second limit position where it abuts against an inner end wall 144a of casing inner chamber 144 (FIG. 10).

Endpiece 125 integrally comprises a casing plug portion 125a, an intermediate portion 125b, and a housing plug portion 125c. Casing plug portion 125a is sealingly friction-fitted in, and is thus fastened to, the open end of inner chamber 144 of inner casing 143, and hence closes off inner chamber 144 to maintain valve actuator 194 enclosed therein. Moreover, housing plug portion 125c is friction-fitted in—and is thus fastened to—housing open end 122b. This fastening of both inner casing 143 and housing 122 to the same endpiece 125 hence ensures the fastening of inner casing 143 to housing 122.

An air outlet channel 127 traverses endpiece 125, and is defined by peripherally spaced holes 127a made in endpiece intermediate portion 125b and in fluid communication with an outwardly opening bore 127b made in endpiece 125c. Air outlet channel 127 establishes fluid communication between the lumen of housing 122 and the outside of valve 120.

Magnet sleeve 145 defines an oblong pin aperture 186 extending transversely therethrough. A seat 148 is inserted at the bottom of the cavity 149 formed within hollow magnet sleeve 145, and defines a hemicylindrical indentation allowing clearance of oblong aperture 186 by seat 148. Furthermore, a hole 150 is made in seat 148, coaxially with the longitudinal axis of elongated valve 120, for the purpose of easing the disassembly of the valve, in particular to facilitate the extraction of the seat out of sleeve cavity 149.

A cylindrical cap member 160 is snugly friction-fitted within sleeve cavity 149. Cap member 160 defines a main cylindrical portion 160a which abuts against seat 148 at one end and is integrally connected to an end wall 160b at the opposite end. End wall 160b roughly registers with the outer rim of magnet sleeve 145, and is pierced at its center so as to allow penetration therethrough of the shank 200a of a fastener 200.

At one end of shank 200a, fastener 200 defines a cross-sectionally V-shaped head 200b. At the end opposite head 200b, shank 200a is attached to a bipolar sleeve magnet 162 (also referred to as an auxiliary magnet or magnetic member herein) nested within the enclosure delimited by the inner wall of cap member 160 and seat 148. As will be described in detail hereinafter, fastener shank 200b loosely penetrates in the hole made at the centre of cap member end plate 160b, and the assembly of fastener 200 and sleeve magnet 162 can thus slidably move within the above-mentioned enclosure between first and second limit positions (as shown in FIGS. 9 and 10 respectively). It is noted that bipolar magnets 162 and 198 are arranged so that they repel one another. This mutually repelling arrangement is schematically illustrated in FIGS. 9-10, where the negative pole of bipolar magnets 162 and 198 face each other.

A hollow piston 164 covers magnet sleeve 145. Piston 164 comprises a head portion 166 defining a cylindrical portion 166a, integrally connected at one end to a transversal end wall 166b chamfered at its outer peripheral edge. End wall 166b is pierced centrally at an air inlet hole 169, and fastener shank 200a penetrates through hole 169, wall 166b surrounding hole 169 being chamfered so as to allow the V-shaped head 200b to snugly fit against it. At its end opposite end wall 166b, cylindrical portion 166a merges with a frustoconical portion 166c tapering towards an annular abutment ring 167. Piston 164 also defines a piston main body 168 extending from abutment ring 167 and integrally linked thereto. Main body 168 is cylindrical and comprises a number of peripherally spaced air circulation openings 170 at the vicinity of abutment ring 167. Moreover, adjacent its free open end 172, main body 168 comprises a pair of registering and diametrically opposed holes 171, 171.

Piston 164 also comprises a magnetic member in the form of a metallic pin 192 which extends through holes 171, 171 of piston main body 168 and through pin aperture 186 of magnet sleeve 145. Both end portions of pin 192 are tightly friction-fitted in holes 171, 171 and pin 192 is thus secured to piston 164. As will be seen hereinafter, the magnetic attraction between metallic pin 192 and magnet 198 of valve actuator 194 will allow operative communication between valve actuator 194 and piston 164, since the latter moves integrally with pin 192.

Piston main body portion 168 has a diameter substantially smaller than the inner wall of housing 122, and the outer wall of main body portion 168 thus clears the inner wall of housing 122. Moreover, both cylindrical portion 166a and abutment ring 167 are dimensioned such that they snugly yet slidably engage the inner wall of housing 122, to allow piston 164 to be slidably movable within housing 122 between first and second positions. In the piston's first position (FIG. 9), the chamfered peripheral edge of end wall 166b snugly and sealingly abuts against the abutment chamfer 140 of inner lining 128, and piston head 166 fully covers and obstructs housing inlet openings 142, so as to cut off fluid communication between inlet openings 142 and valve outlet opening 138 and to seal the substance channel formed therebetween. In the piston's second position (FIG. 10), the free open end 172 of piston main body 168 abuts against the abutment shoulder 147 of inner casing 143, and piston head 166 clears inlet openings 142. In this piston's second position, fluid communication between inlet openings 142 and valve outlet opening 138 is established, and the piston clears the substance channel formed therebetween.

The operation of valve 120 will now be described, when it is used on a container such as container 10 of FIG. 1 for example. When the container stands in an upright position, the annular housing abutment flange 132 of valve 120 rests on the mouth of the container, and the rest of the valve extends downwardly inside the container. In this position, valve 122 is arranged vertically, and valve actuator 194 rests at the bottom of the inner casing's inner chamber 144 and rests against plug 125, as shown in FIG. 9. Moreover, in this rest position, sleeve magnet 162 is sunk at the bottom of hollow sleeve cavity 149 and abuts against seat 148, and the V-shaped head 200b of fastener 200 abuts around and seals air inlet hole 169 (fastener head 200b can be regarded as a sealing member). Moreover, in this position, the magnetic attraction exerted by sleeve magnet 162 on pin 192, is much greater than the magnetic attraction exerted on pin 192 by valve actuator magnet 198, since the latter is significantly spaced from pin 192 (see FIG. 9). In this position, sleeve magnet 162 thus draws pin 192 towards it, and since piston 164 moves integrally with pin 192, this attraction force causes piston 164 to be drawn upwardly towards its first position, i.e. until it abuts against abutment chamfer 140 of lining 128. Metallic pin 192 and sleeve magnet 162 can thus be said to cooperate to act as a first biasing member biasing piston 164 towards its first position. In the first position of piston 164, valve 120 is said to be in a closed condition, since liquid is prevented from flowing therethrough.

If the container equipped with valve 120 is tilted downwardly beyond a threshold angular position, for example where the valve is tilted of more than 90 degrees from its upright rest position such that the elongated valve 120 is positioned with the housing second end 122b at a higher position relative to the housing first end 122a, valve actuator 194 will slide along chamber 144 under the influence of gravity towards is second limit position until it abuts against inner end wall 144a of the inner casing's inner chamber 144, as shown in FIG. 10. In this position, valve actuator magnet 198 is moved much closer to sleeve magnet 162 and pin 192, and the magnetic interaction therebetween becomes considerable. Consequently, valve actuator magnet 198 repels sleeve magnet 162 which causes the assembly of sleeve magnet 162 and fastener 200 to move away from seat 148, towards a second limit position where sleeve magnet 162 abuts against end wall 160b of cap member 160, and where the V-shaped head 200b of fastener 200 clears air inlet hole 169 made in piston head 166. Concomitantly, valve actuator magnet 198 will exert a magnetic attraction force on metallic pin 192 which overtakes the bias exerted thereon by sleeve magnet 162, thus causing piston 164 to be drawn towards valve actuator magnet 198 and towards its second limit position, where the free end 172 of piston main body 168 abuts against abutment shoulder 147 and where piston head 166 clears inlet openings 142. In this position of piston 164, valve 120 is said to be in an open condition.

Metallic pin 192 and valve actuator magnet 198 can thus be said to cooperate to act as a second biasing member which is capable of biasing piston 164 towards its second position, whereby the bias of this so-called second biasing member overtakes the bias of the first biasing member (formed by metallic pin 192 and sleeve magnet 162) when valve actuator 194 is in its second position.

In this open condition of valve 120, as shown particularly in FIG. 10, piston head portion 166 clears inlet openings 142 and liquid from the container may flow through the valve inlet openings 142 and the valve outlet openings 138 to pour out of the container. Simultaneously, air may flow sequentially through the piston air inlet hole 169 while flowing around fastener shank 200a which extends therethrough, into the area within the piston head portion 166, through the air circulation openings 170 of piston main body 168, then along grooves 178 made on inner casing main body portion 146, and then through air outlet channel 127 outwardly of valve 120, and into the container in which the valve is installed. This incoming air flow will of course promote a more steady liquid flow out of the container since it will not be necessary for the air to flow through the valve liquid inlet openings 142—which air is required to prevent a vacuum from being created within the container due to the outpouring of liquid.

In the embodiment of FIG. 8-10, the switching of valve 120 from its closed to its open conditions will not occur instantly after the valve is tilted beyond the above-mentioned angular threshold position. Indeed, after valve 120 is tilted beyond the determined angular threshold position, valve actuator 194 will start to move towards its second position but it will not reach it instantly. This is of course due, inter alia, to the friction at the interface between valve actuator 194 and the peripheral wall of inner chamber 144 which hinders the movement of valve actuator 194 towards its second position. A delay therefore exists between the instant when the valve is tilted beyond its determined threshold position and the instant when the actuator reaches its second position. It is only when valve actuator 194 has reached its second position (FIG. 10), or at least has reached a critical position close enough from metallic pin 192, that the magnetic attraction force on pin 192 becomes important enough to pull and actuate piston 164 towards its second position, to allow valve 120 to reach to its open condition. A delay thus exists between the instant when the valve is tilted beyond its determined threshold position and the instant when the valve reaches its open condition.

It is noted that this delay could be increased by filling inner chamber 144 with a fluid for dampening the movement of valve actuator 194 therein. Alternately, this delay could be increased by providing means for increasing the friction at the interface between valve actuator 194 and the peripheral wall of inner chamber 144, to further hinder the movement of the valve actuator 194 between its first and second positions and to therefore increase the delay between instant when the valve is tilted beyond its determined threshold position and the instant when it switches to its open condition.

It is understood that each one of the embodiments of the valve of the present invention, with some modifications to its design that are considered to be within the scope of the present invention, could have its functionality reversed, i.e. the valve would switch from its open to its closed condition when it is titled beyond a determined angular threshold position. For example, such a modified valve could be used on an air outlet provided on a combustible liquid container carried by a vehicle for delivering the combustible liquid in designated areas. This air outlet is used to allow air into the container when combustible is dispensed, to prevent a vacuum from being created in the container. In such a case, a default opened state of the air outlet is desired to allow air to enter the container. However, should the container accidentally tilt such as if the vehicle is implicated in a road accident and is turned over, then it is desirable to prevent the combustible in the container from spilling out of the container. Consequently, the valve of the present invention could be used to close the air outlet when the container reaches a position in which the valve is tilted beyond a determined threshold angular position relative to a horizontal axis. In this particular case, the determined threshold angular position could be a position in which the valve is tilted sidewardly of at least a minimal angular value (e.g. 30 or 45 degrees) although it remains with its housing first end located over the housing second end, so as to prevent a liquid spill even though the container is not necessarily completely turned over.

Thus, the biasing member biasing the piston of the flow control valve of the invention could bias the piston towards a constant one of its first and second limit positions, i.e. either its first or its second position, but always the same one of those two. The valve actuator would consequently act on the piston to move the latter towards the one of its first and second positions opposite the constant one of its first and second positions towards which the biasing member continuously biases the piston, upon the valve being positioned beyond a determined threshold angular position relative to a horizontal axis.

According to another alternate embodiment of the invention, the valve could also comprise an inner chamber which could be tilted independently of the valve main housing.

It is further understood that the air channel provided in valve of the present invention is advantageous, but not compulsory. This air channel is defined as follows:
in the embodiment of FIGS. 1-7: in the piston second position (FIG. 3, 5, 7), the air channel is defined as the channel extending from the valve liquid outlet openings 38, through the inner tube air inlet opening 84, then through the inner tube air outlet openings 86, into the peripheral area located between magnet sleeve 45 and piston head portion 66, then through the piston inclined openings 70, out into the peripheral area located between, on one hand, the piston main body 68 and the inner casing 43 and, on the other hand, the housing peripheral wall 24, through the spacing between the piston main body ring 80 and the inner casing end wall 48, then between the inner casing end wall 48 and the housing end wall 26, and finally out through the air tube 27.
in the embodiment of FIG. 8-10: in the piston second position (FIG. 10), the air channel is defined as the channel extending from the gap formed between the air inlet hole 169 and the fastener shank 200a, into the area within the piston head portion 166, through air circulation openings 170 of piston main body 168, along grooves 178 made on inner casing main body portion 146, and through air outlet channel 127 outwardly of valve 120.

This air channel promotes a steady flow of the liquid pouring out through the valve since the air flowing into the container to replace the liquid pouring out does not have to flow through the same valve liquid inlet openings as the liquid itself, but theoretically the air could indeed flow into the container through liquid inlet openings if required.

It is noted that if the substance in the valve-equipped container is a gas, then the above-mentioned air channel would not be installed on the flow control valve of the present invention to prevent the gas in the container from escaping through the air channel, especially if the gas in question is not as dense as air.

1. A flow control valve for controlling the flow of a substance capable of flowing therethrough, said flow control valve comprising:
a housing comprising a substance inlet opening, a substance outlet opening and a substance channel extending between said substance inlet and outlet openings for allowing the substance to flow through said flow control valve;
a piston carried by said housing and movable relative to said housing between a first piston position in which said piston seals said substance channel for preventing the substance from flowing therethrough, and a second piston position in which said piston clears said substance channel for allowing the substance to flow therethrough;
a first biasing member continuously biasing said piston towards a constant one of said first and second piston positions;
a guide channel carried by said housing;
a valve actuator movable along and within said guide channel between first and second actuator positions,
a second biasing member capable of biasing said piston against the bias of said first biasing member towards the one of said first and second piston positions opposite said constant one of said first and second piston positions, whereby the bias of said second biasing member overtakes the bias of said first biasing member on said piston when said valve actuator is in said second actuator position, without however overtaking the bias of said first biasing member when said valve actuator is in said first actuator position so that said piston will remain in said constant one of said first and second piston positions when said valve actuator is in said first actuator position;
wherein upon said elongated guide channel being positioned beyond a determined threshold angular position relative to a horizontal axis, said valve actuator will progressively move from said first actuator position towards said second actuator position resulting in the bias of said second biasing member overtaking the bias of said first biasing member on said piston and said piston thus being moved towards the one of said first and second piston positions opposite said constant one of said first and second piston positions, with the movement of said piston being delayed according to the time it takes for said valve actuator to move from said first actuator position to said second actuator position.

2. The flow control valve as defined in claim I, wherein said second biasing member comprises a piston magnetic member carried by said piston, and an actuator magnetic member carried by said valve actuator that can magnetically cooperate with said piston magnetic member, whereby at said second actuator position of said valve actuator, magnetic interaction forces between said piston and actuator magnetic members will overtake the bias of said first biasing member on said piston to move said piston towards said one of said first and second piston positions opposite said constant one of said first and second piston positions.

3. The flow control valve as defined in claim 2, wherein said first biasing member includes an auxiliary magnetic member carried by said housing that magnetically cooperates with said piston magnetic member to continuously bias said piston towards said constant one of said first and second piston positions.

4. The flow control valve as defined in claim 3, wherein said actuator magnetic member is an actuator magnet, said auxiliary magnetic member is an auxiliary magnet and said piston magnet member is a metallic member attracted by both said actuator and auxiliary magnetic members.

5. The flow control valve as defined in claim 3, wherein said housing further comprises an air channel at least partly distinct from said substance channel and extending through said valve housing for allowing air to flow through said valve in at least one of said first and second piston positions.

6. The flow control valve as defined in claim 5, wherein said auxiliary magnetic member is movable between a first auxiliary position in which said auxiliary magnetic member seals said air channel for preventing air from flowing therethrough, and a second auxiliary position in which said auxiliary magnetic member clears said air channel for allowing air to flow therethrough.

7. The flow control valve as defined in claim 1, wherein said guide channel is a fluid-tight elongated inner chamber in which said valve actuator is movable, said inner chamber containing an inner chamber fluid that dampens and consequently delays the movement of said valve actuator between said first and second actuator positions.

8. The flow control valve as defined in claim 7, wherein said valve actuator is a floater having a lesser density than that of said inner chamber fluid.

9. The flow control valve as defined in claim 8, wherein said second biasing member comprises an actuator attachment member linking said valve actuator to said piston and extending through a wall of said inner chamber in a fluid-tight fashion.

10. The flow control valve as defined in claim 9, wherein said attachment member is flexible.

11. A flow control valve for controlling the flow of a substance capable of flowing therethrough, said flow control valve comprising:
a housing comprising a substance inlet opening, a substance outlet opening and a substance channel extending between said substance inlet and outlet openings for allowing the substance to flow through said flow control valve;
a piston carried by said housing and movable relative to said housing between a first piston position in which said piston seals said substance channel for preventing the substance from flowing therethrough, and a second piston position in which said piston clears said substance channel for allowing the substance to flow therethrough;
a biasing member continuously biasing said piston towards a constant one of said first and second piston positions;
an elongated guide channel within said housing; and
a valve actuator movable along and within said elongated inner chamber between first and second actuator positions, said valve actuator operatively communicating with said piston, and said valve actuator capable of exerting an actuator force on said piston which increases when said valve actuator moves from said first to said second position, said actuator force being opposite to the bias exerted by said biasing member on said piston;
wherein upon said elongated inner chamber being positioned beyond a determined threshold angular position relative to a horizontal axis, said valve actuator will move towards said second actuator position said actuator force will overtake the bias exerted on said piston by said biasing member and said piston will thus be moved towards the one of said first and second positions opposite said constant one of said first and second positions, with the movement of said piston being delayed according to the time it takes for said valve actuator to move from said first actuator position to said second actuator position.

12. The flow control valve as defined in claim 11, wherein said guide channel is a fluid-tight inner chamber tight and defines an inner chamber wall enclosing a fluid, said valve actuator has a different density than that of said fluid, said valve actuator and said piston operatively communicate through the instrumentality of an actuator attachment member linking said valve actuator to said piston and extending through said inner chamber wall in a fluid-tight fashion, and wherein upon said elongated inner chamber being positioned beyond a determined threshold angular position relative to a horizontal axis, the movement of said piston between said first and second positions will be delayed by the fact that the movement of said valve actuator within said inner chamber will be dampened by said fluid.

13. The flow control valve as defined in claim 12, wherein said valve actuator is a float member having a lesser density than that of said fluid.

14. The flow control valve as defined in claim 12, wherein said actuator attachment member comprises a flexible element, and wherein the overtaking of the bias of said biasing member by said actuator force to move said piston towards said one of said first and second positions opposite said constant one of said first and second positions is delayed until said flexible element becomes taught between said valve actuator and said piston after said inner chamber is moved to be positioned beyond said determined threshold angular position.

15. The flow control valve as defined in claim 12, wherein said biasing member comprises first and second portions magnetically attracted to each other and respectively provided on said housing and on said piston.

16. The flow control valve as defined in claim 13, wherein said float member comprises a skirt impeding the displacement of said float member towards a constant determined direction within said inner chamber.

17. The flow control valve as defined in claim 11, wherein said piston comprises a metallic member moving integrally therewith, and said valve actuator is slidable within said guide channel and comprises a valve actuator magnet located much closer from said piston metallic member when said valve actuator is in its said second position than when it is in its said first position, said valve actuator magnet capable of exerting a magnetic attraction force on said metallic member, said magnetic attraction force being said actuator force, wherein said magnetic attraction between said piston metallic member and said valve actuator magnet establishes operative communication between said piston and said valve actuator.

18. The flow control valve as defined in claim 17, wherein said biasing member comprises said metallic member attached to said piston and a biasing member magnet connected to said housing, said biasing member magnet and said metallic member continuously attracting each other.

19. The flow control valve as defined in claim 18, wherein said biasing member magnet is movable between a first position adjacent to said metallic member, and a second position relatively farther from said metallic member, said biasing member magnet and said valve actuator magnet being in mutually repelling arrangement, and wherein when said valve actuator is moved in its second position, said biasing member magnet is repelled by said valve actuator magnet and moved in its second position.

20. The flow control valve as defined in claim 11, wherein said housing further comprises an air channel at least partly distinct from said substance channel and extending through said valve housing for allowing air to flow through said valve in at least one of said first and second positions of said piston.
